(19) United States
(12) Patent Application Publication
(10) Pub. No.: US 2026/0240218 A1
(43) Pub. Date: Aug. 20, 2026

(54) Cooker and Temperer

(71) Applicant: Lyco Manufacturing, Inc., Columbus, WI (US)

(72) Inventors: William David Zittel, Columbus, WI (US); Daniel Dolan Maupin, Corvallis, OR (US); Steven Jon Schultz, Beaver Dam, WI (US); Jeffrey Scott Zittel, Columbus, WI (US)

(21) Appl. No.: 19/647,185

(22) Filed: Apr. 14, 2026

Related U.S. Application Data
(63) Continuation of application No. PCT/US2024/051248, filed on Oct. 14, 2024.
(60) Provisional application No. 63/544,331, filed on Oct. 16, 2023.
(60) Provisional application No. 63/551,728, filed on Feb. 9, 2024.

(51) Int. Cl. A23N 12/04; A23L 5/10; A23N 12/06

(52) U.S. Cl. CPC A23N 12/04; A23L 5/13; A23N 12/06

(57) ABSTRACT

A method and apparatus for cooking food product is disclosed. It includes a blancher, such as a rotary blancher, a tempering belt and a transfer mechanism to transfer product from the blancher to the temperer. In various embodiments, the methods and apparatus can be utilized to cook various food products, such as rice.

### CROSS-REFERENCE TO RELATED PATENT APPLICATIONS

The present application is a continuation of International Application No. PCT/US2024/051248, filed Oct. 14, 2024, which claims the benefit of and priority to U.S. Application No. 63/544,331 filed on Oct. 16, 2023, and U.S. Application No. 63/551,728 filed on Feb. 9, 2024, each of which is incorporated herein by reference in its entirety.

### BACKGROUND OF THE INVENTION

The present disclosure relates generally to the art of cooking food in large industrial quantities. More specifically, it relates to industrial cookers that partially cook and then temper food.

The present invention relates specifically to a cooker and temperer. Rice is among the most consumed commodity in the world, and processing rice is an old art. Modern large scale processing of rice has leaned toward two processes-batch processing and continuous processing. Examples of prior art rice cooking include U.S. Pat. Nos. 4,677,907, 4,934,259, 4,873,917, 6,101,926, 6,056,986, 6,035,764, 5,083,506 and US Patent Publication US2017-0099863.

Rice cooking is a complex art that has many nuances and preferences. In many rice cooking processes, rice is immersed in hot water until the moisture content reaches maximum saturation level. This would typically take about 20 minutes. A high moisture content with high temperature is often used to gelatinize the starches to make the rice consumable. The water quality is often maintained with a starch content below specific levels to keep the process consistent.

Once rice has reached moisture saturation levels, it is difficult for the rice to further absorb additional water or spices. For rice cooking where spices are desired to be added to the rice and absorbed by the rice, the spices are added to the hot water and cooked the appropriate time. This has successfully been done by many prior art applications in a batch method process.

Batch processing is the most common form, and there is much prior art relating to processing rice in batches, from stove-top, to automated home versions, to large scale kitchens. Often, this method of cooking is a full absorption method, where the precise amount of water is added to the cooking batch, and the rice absorbs all the available water, leaving fully cooked and sticky rice.

But fully absorbed and cooked rice is difficult to handle in a continuous process. One prior art continuous rice cooking technique uses steaming belts. Rice can be fully hydrated, and fully cooked on such belts. However, belt units have difficulty in discharging cooked rice, and are difficult to clean, and the rice can be difficult to handle after cooking. Moreover, because the rice is cooked to saturation it is difficult to add more water, spices or flavoring to the rice.

Another prior art technique is to use a steam auger with a reversing auger to agitate the rice while steaming and cooking the rice. This technique uses less water. But, this prior art cannot be used for large scale rice cooking, can damage the kernels of rice, and has other limitations.

It is desirable to fully cook rice (soft interior) but to a level lower than saturation so that rice can still absorb some spice solution. However, this is very difficult to do with standard water immersion cookers. It is also difficult to do with cookers that spray water onto the rice and heat with steam on a belt.

Prior art cookers, such as that shown in U.S. Pat. No. 7,735,415 can consistently cook rice in a traditional immersion manner to a fully saturated condition. But cooking to a fully cooked condition below saturation is difficult within the machine. Other prior art pressure cookers can also rapidly cook rice to saturation levels under pressure and achieve a consistent product with slight gelatinization differences due to the higher temperature, but still cannot achieve fully cooked (without hard centers) within the machine at lower moisture levels (<59% moisture). The same is true for rotary drum cookers. Batch machines where moisture level can be highly regulated can successfully cook rice in this manner, but are limited in production capability.

Using tempering belts is a known strategy for allowing other food product to equilibrate before further processing, for example beans. Known tempering belts are large and are difficult to clean. This is especially true with systems that rely solely on belt processing. Excessive length of equipment is often used to insure a resemblance of consistency. Tempering can also be a slow process.

Accordingly, a continuous process that can consistently cook rice particles without hard centers and yet be below saturation level so that spice solution can still be absorbed into the rice. Tempering using a technique that is fast is also desirable.

### SUMMARY OF THE INVENTION

According to a first aspect of the disclosure a food product cooker includes a rotary blancher and a tempering belt. The rotary blancher has a blancher inlet and a blancher outlet. The temperer has a tempering belt, a tempering belt inlet and a tempering belt outlet. The tempering belt inlet and blancher outlet are disposed to provide for the transfer of food product from the blancher outlet to the tempering belt inlet.

According to a second aspect of the disclosure a method of cooking food product includes providing food product to a rotary blancher and then moving the food product through the rotary blancher. The food product is cooked to a desired moisture level as it moves through the rotary blancher and then it is transferred from the rotary blancher to a tempering belt. The food product is moved on the tempering belt at a controlled temperature to allow the moisture in the food product to trend towards equilibration at the controlled temperature.

A bucket transfer is disposed between the rotary blancher and the tempering belt in one alternative.

The rotary blancher includes a supply of fluid and also has a controller, including a sub-saturation module connected to the rotary blancher and to the supply of fluid, in another alternative.

The tempering belt includes a source of heat, and the controller further includes a temperature control module in one embodiment.

The tempering belt is a continuous tempering belt, and/or the rotary blancher is a continuous blancher, and/or the food is provided continuously, and/or the food is transferred continuously in various embodiments.

A venturi flume transfer is disposed between the rotary blancher and the tempering belt in one alternative.

A temperature-controlled water bath near the tempering belt is included in one embodiment.

The water bath and tempering belt are disposed within a housing in various embodiments.

One embodiment of the invention relates to a food product cooker including a rotary blancher, having a blancher inlet and a blancher outlet, and a temperer, having a tempering belt, a tempering belt inlet and a tempering belt outlet. The tempering belt inlet and blancher outlet are disposed to provide for the transfer of food product from the blancher outlet to the tempering belt inlet.

In various embodiments, the food product cooker includes a bucket transfer disposed between the rotary blancher and the tempering belt.

In various embodiments, the rotary blancher includes a supply of fluid, and the food product cooker includes a controller, including a sub-saturation module connected to the rotary blancher and to the supply of fluid.

In various embodiments, the tempering belt includes a source of heat, and the controller further includes a temperature control module.

In various embodiments, the rotary blancher is a continuous blancher. In various embodiments, the tempering belt is a continuous tempering belt.

In various embodiments, the food product cooker includes a venturi flume disposed between the rotary blancher and the tempering belt.

In various embodiments, the food product cooker includes a temperature-controlled water bath below the tempering belt.

In various embodiments, the food product cooker includes a housing, wherein the water bath and tempering belt are disposed within the housing.

One embodiment of the invention relates to a method of cooking food product including providing food product to a rotary blancher, moving the food product through the rotary blancher, cooking the food product to a desired moisture level as it moves through the rotary blancher, transferring the food product from the rotary blancher to a tempering belt, and moving the food product on the tempering belt at a controlled temperature to allow the moisture in the food product to trend towards equilibration at the controlled temperature.

In various embodiments, moving the food product through the rotary blancher is a continuous process.

In various embodiments, moving the food product on the tempering belt is a part of the continuous process.

In various embodiments, providing the food product is part of the continuous process.

In various embodiments, transferring the food product includes lifting the food product in buckets.

In various embodiments, transferring the food product is part of the continuous process.

In various embodiments, transferring the food product includes transferring the food product on a flume using a venturi effect.

In various embodiments, the method includes controlling the temperature of a water bath disposed beneath the tempering belt.

One embodiment of the invention relates to a food product cooker including means for cooking the food product to a desired moisture level, means for tempering the food product after it has been cooked to the desired moisture level, and means for transferring the food product from the means for cooking to the means for tempering. The means for transferring is operatively connected to an output of the means for cooking and further operatively connected to the means for tempering.

In various embodiments, the means for cooking is a continuous means for cooking.

In various embodiments, the means for tempering belt is a continuous means for tempering.

In various embodiments, the means for transferring includes a bucket lift.

In various embodiments, the means for transferring the food product is a continuous means for transferring.

In various embodiments, the means for transferring includes a venturi flume.

In various embodiments, the means for tempering includes a tempering belt, a water bath disposed near the tempering belt, and a means for controlling the temperature of a water bath disposed beneath the tempering belt.

One embodiment of the invention relates to a food product cooker including a blancher, having a blancher inlet and a blancher outlet, and a temperer, having a tempering belt, a tempering belt inlet and a tempering belt outlet, and a source of pulsed electric field energy. The tempering belt inlet and blancher outlet are disposed to provide for the transfer of food product from the blancher outlet to the tempering belt inlet, and the source of energy is disposed to direct the pulsed electric field energy towards the belt.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a rice cooker in accordance with the preferred embodiment;

FIG. 2 is an exploded view of a lift in accordance with an embodiment;

FIG. 3 is a perspective view of a transfer mechanism in accordance with one embodiment;

FIG. 4 is diagram of a controller in accordance with one embodiment;

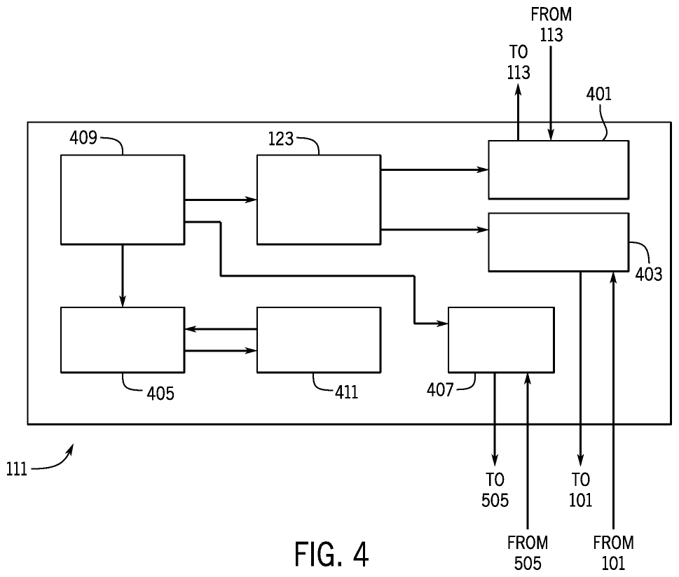

FIG. 5 is an exploded view of a temperer in accordance with one embodiment; and

FIG. 6 is a temperer in accordance with one embodiment.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION

While the present disclosure will be illustrated with reference to a particular blancher and temperer used to cook food products, such as rice and/or beans, it should be understood at the outset that the claimed cooker can also be implemented with other blanchers, temperers, and can be used to cook food product other than rice.

For example, while the preferred embodiment uses a particular rotary screw blancher, other rotary screw blanchers could be used, as well as other blanchers such as a drum blancher. Moreover, the preferred embodiment is described as being used for cooking rice, but other food products could be cooked. For example using the described cooker to cook potatoes provides for an increased product recovery rate because the corners of the finished fully cooked dices are not rounded off. Even fragile dry beans can be cooked using the described cooker.

Generally, the preferred embodiment provides for water to be absorbed and free starch to be removed in an easy to clean immersion unit that provides very consistent processing of the food particles. After the rice is cooked in the immersion cooker, it is transferred via a transfer flume to a tempering belt that can hold the rice at the same or lower temperature for an extended period of time, to allow the moisture level to equilibrate but to be at a level below saturation, to allow the rice to be further processed to accept desired spices.

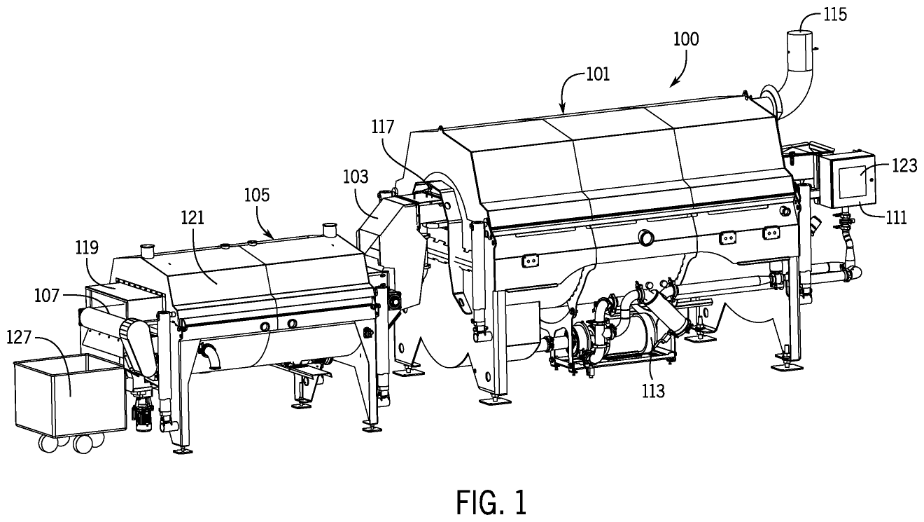

The preferred embodiment of the food product cooker is shown in FIG. 1 as 100, and includes a rotary screw blancher 101, a transfer mechanism 103, a temperer 105. Alternatives provide for using a rotary drum blancher, or other rotary blancher. Blancher 101 includes a blancher inlet 115 and a blancher outlet 117. Transfer mechanism 103 includes, in the preferred embodiment a ferris wheel and bucket (located inside rotary screw blancher 101). Temperer 105 includes a tempering belt 107, having a tempering belt inlet (not shown in the view) and a tempering belt outlet 119. Tempering belt, as used herein, refers to a belt on which rice or food product is moved from one location to another, and wherein the rice is subject to energy, heat and/or steam that allows the internal temperature of the rice to equilibrate, without cooking the rice to saturation. The energy can be any type of energy, including mechanical, chemical, electrical, electromagnetic, thermal, sound, and nuclear energy. The energy can be pulsed, such as pulsed electric fields, pulsed electrical, pulsed mechanical, or the energy can be constant or varying slowly. Saturation, as used herein, refers to rice or food product absorbing water to the point where it can no longer absorb more water.

In the preferred operation, cooker 100 is used to cook rice using a prior art rotary screw blancher to hydrate the rice to near the desired final moisture level (below saturation) and then transfer the rice out of the rotary screw blancher onto a tempering belt that allows the moisture level to equilibrate to final desired moisture level (below saturation) while holding temperature at the desired process conditions. All this is preferably done in a continuous process.

Specifically, rice is provided/introduced to blancher 101 through blancher inlet 115. Rotary screw blancher 101 is partially filled with water (or steam) heated to a desired temperature. An auger (inside rotary screw blancher 101) moves the rice through the water bath. The rotational speed of the auger determines the transit time of the rice. The time and temperature determine the extent to which the rice is cooked, and is set to provide the desired moisture level for the rice. Rotary screw blancher 101 is constructed and operates in accordance with the prior art rotary screw blanchers, such as that shown in U.S. Pat. No. 7,735,415, hereby incorporated by reference.

After the rice (or other food product) is cooked to the desired moisture level, temperature or other characteristic, the rice is transferred from rotary screw blancher 101 to tempering belt 107. The transfer mechanism can be a prior art transfer mechanism, such as a ferris wheel/bucket system such as that shown in U.S. Pat. No. 7,735,415, or a venturi effect flume such as that shown in U.S. Pat. No. 11,154,066, hereby incorporated by reference.

The rice or food product is moved on tempering belt 107 at a controlled temperature and speed to allow the moisture in the food product to trend towards equilibration at the controlled temperature. A water bath is provided near tempering belt 107 (preferably below), and a housing 121 of temperer 105 contains the water bath and belt 107. The water bath is preferably maintained close to boiling so radiant heat and steam temper the rice. Baffles are preferably provided to reduce heat and steam loss where belt 107 enters and leaves housing 121. Controlled temperature, as used herein, refers to controlling temperature to a desired set point or desired profile with temperatures varying over time or location. Controlling the temperature, as used herein, refers to controlling temperature to a desired set point or desired profile with temperatures varying over time or location.

After tempering, the rice is provided to station 127 where it can be moved for packaging or further processing.

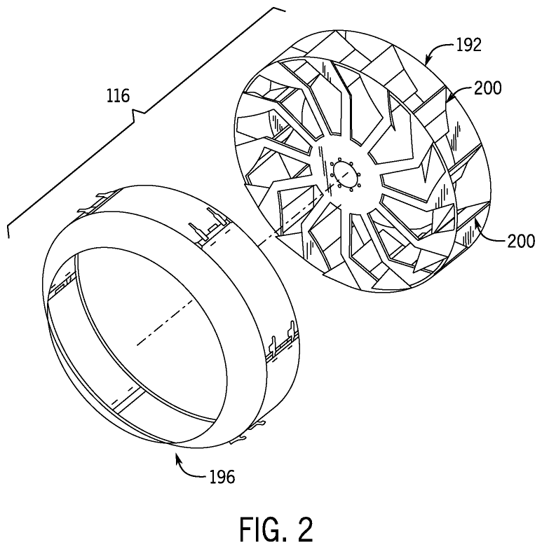

An exploded view of a ferris wheel and bucket lift assembly 116 is shown in FIG. 2. The lift assembly 116 is positioned near blancher outlet 117 and is part of transfer mechanism 103. The lift assembly 116 includes a lift portion 192 and a housing portion 196. The lift portion 192 includes a plurality of circumferentially spaced apart radial lifting buckets 200 used for transferring food product. In operation, the lift assembly 116 rotates with the auger in blancher 101. The auger advances food product to lift assembly 116.

A controller 111 controls the speed and temperature of blancher 101 and temperer 105 according to a user selected recipe, in the preferred embodiment. For example, several rice recipes can be available, and the user selects rice recipe #2. Controller 111 includes a sub-saturation module 123 connected to the rotary screw blancher and to the supply of fluid to set the temp and time to cook the rice to the desired sub-saturation level. Sub-saturation, as used herein, refers to rice or food product that is capable of absorbing more water. Sub-saturation module, as used herein, refers to a control module for a cooker/blancher which sets heat and time so that the rice or food product is cooked, but not cooked to saturation.

One embodiment provides that the rotary screw blancher is a continuous blancher. Continuous blancher, as used herein, refers to a blancher that continuously receives rice or food product and continuously outputs rice or food product. Another embodiment provides that the tempering belt is a continuous tempering belt. Continuous tempering belt, as used herein, refers to a belt that moves continuously, and continuously receives rice or food product and continuously outputs rice or food product.

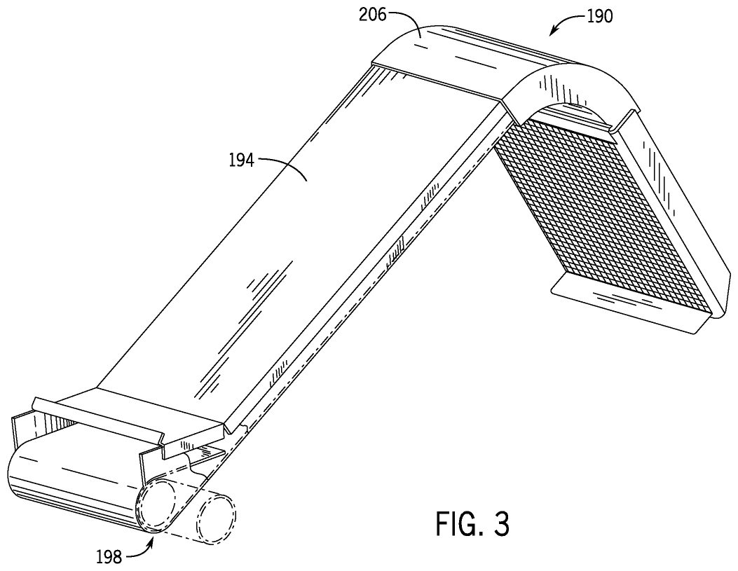

Another embodiment provides that transfer mechanism 103 includes a venturi flume such as that in U.S. Pat. No. 11,154,066, disposed between the rotary screw blancher and the tempering belt, as shown in FIG. 3. Venturi flume 190 includes a conduit 194, a fluid discharge 198, a pressurized fluid source (not shown), and a convex guide member 206. The fluid discharge 198 and a pump generate a vacuum force at the inlet of conduit 194. The vacuum force helps draw food product through flume. Venturi flume, as used herein, refers to a flume with water injected into it so that food product is moved by the venturi effect. Using a venturi flume provides for a continuous transfer.

One embodiment provides that controller 111 includes sub-saturation module 123, a temperature control module 401, a speed control module 403, a temperature control module 405, a speed control module 407 and a user input module 409. The user selects the desired recipe on user input module 409, which can includes a touch screen, dial, etc. Controller 111 provides that selection to sub-saturation module 123, which is sets a desired temperature target (set point, waveform, range, etc.) and provides the target to temperature control module 401. The set point can be obtained from a look-up table or digital memory, and sub-saturation module 123 is preferably a digital controller. Temperature control module 401 is also preferably a digital control, such as a microprocessor, PLC, etc., and provides the temperature target to heater 113 (FIG. 1). The system can include feedback from heater 113 and/or blancher 101 to temperature control module 401.

Sub-saturation module 123 also sets a speed target based on the user selection, and provides the target speed to speed control module 403. Speed control module 403 is connected and controls the rotational speed of blancher 101, preferably using a VFD. The system can include feedback from blancher 101 (FIG. 1) to speed control module 403. Temperature control module, as used herein, refers to a control module for a cooker/blancher which sets heat to which the rice or food product is subject.

Controller 111 also provides the user selected recipe to temperature control module 405, which sets a temperature set point for temperer 105. The set point can be obtained from a look-up table, and temperature control module 405 is preferably a digital controller. Temperature control module 405 provides the temperature target to a water bath heater or steam header 411. The system can include feedback from heater or steam header 411 and/or temperer 105 to temperature control module 405.

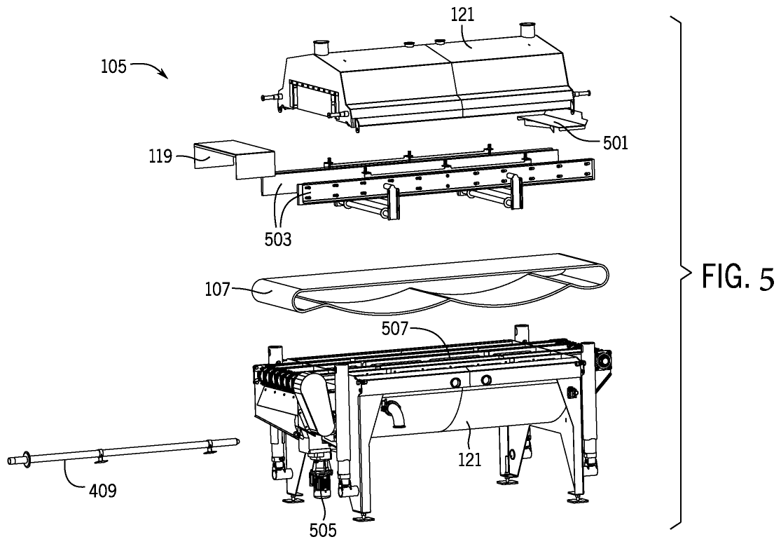

Controller 111 also provides the user selected recipe to speed control module 407, which sets a speed set point for temperer 105. The set point can be obtained from a look-up table, and speed control module 407 is preferably a digital controller. Speed control module 407 provides the temperature target to a gear motor 505 (FIG. 5) that drives tempering belt 107 (FIG. 1). The system can include speed feedback from gear motor 505 to speed control module 407.

Referring now to FIG. 5, an exploded view of an embodiment of temperer 105 is shown. Housing 121 contains belt 107 and a water bath 507 in the lower part of housing 121. Tempering belt outlet 119 preferably includes a cover and baffles. A tempering belt inlet 501 preferably includes a cover that smooths the product to provide a more even distribution, and includes baffles in one embodiment. A pair of product guides 503 help maintain the product on belt 107. Steam header 411 provides steam to maintain the water bath at the target temperature. Gear motor 505 drives belt 107 at the target speed.

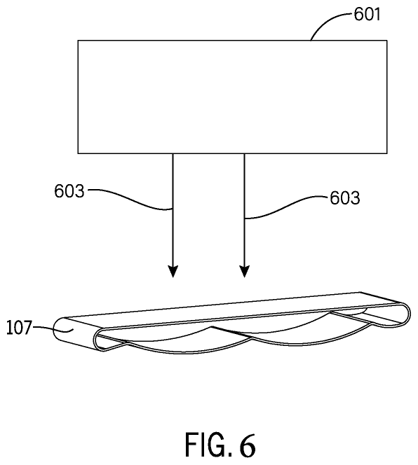

Another alternative provides for using pulsed electric field energy, or another type of energy, that can rapidly temper the product. Types of energy can be combined, such as pulsed electric or electric field energy and thermal energy. The electric fields energy can be applied while the product (such as beans) is in a water bath (that can be heated). It could also be applied without the product being subject to thermal energy. One embodiment provides for using electric field energy followed by a water soak in a container that is not a rotary blancher. Depending on the energy source, the product may remain above the water in the tank below or deposited in the water for a period of time to enhance the moisture process variables. FIG. 6 shows an embodiment wherein an electric field source 601 is disposed in housing 121 to direct pulsed electric field energy toward belt 107. A water bath can be provided, or omitted. The arrows 603 represent electric filed energy. Depending on the energy source, the product may remain above the water in the tank below or deposited in the water for a period of time to enhance the moisture process variables.

Numerous modifications may be made to the present disclosure which still fall within the intended scope hereof. Thus, it should be apparent that there has been provided a method and apparatus for cooking rice and other food product that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A food product cooker comprising:
a rotary blancher, having a blancher inlet and a blancher outlet; and
a temperer, having a tempering belt, a tempering belt inlet and a tempering belt outlet, wherein the tempering belt inlet and blancher outlet are disposed to provide for the transfer of food product from the blancher outlet to the tempering belt inlet.

2. The food product cooker of claim 1, further comprising a bucket transfer disposed between the rotary blancher and the tempering belt.

3. The food product cooker of claim 1, wherein the rotary blancher includes a supply of fluid, and further comprising a controller, including a sub-saturation module connected to the rotary blancher and to the supply of fluid.

4. The food product cooker of claim 3, wherein the tempering belt includes a source of heat, and wherein the controller further includes a temperature control module.

5. The food product cooker of claim 4, wherein the rotary blancher is a continuous blancher.

6. The food product cooker of claim 4, wherein the tempering belt is a continuous tempering belt.

7. The food product cooker of claim 1, further comprising a venturi flume disposed between the rotary blancher and the tempering belt.

8. The food product cooker of claim 1, further comprising a temperature-controlled water bath below the tempering belt.

9. The food cooker of claim 1, further comprising a housing, wherein the water bath and tempering belt are disposed within the housing.

10. A method of cooking food product, comprising;
providing food product to a rotary blancher;
moving the food product through the rotary blancher;
cooking the food product to a desired moisture level as it moves through the rotary blancher;
transferring the food product from the rotary blancher to a tempering belt; and
moving the food product on the tempering belt at a controlled temperature to allow the moisture in the food product to trend towards equilibration at the controlled temperature.

11. The method of claim 10, wherein moving the food product through the rotary blancher is a continuous process.

12. The method of claim 11, wherein moving the food product on the tempering belt is a part of the continuous process.

13. The method of claim 11, wherein providing the food product is part of the continuous process.

14. The method of claim 13, wherein transferring the food product includes lifting the food product in buckets.

15. The method of claim 13, wherein transferring the food product is part of the continuous process.

16. The method of claim 15, wherein transferring the food product includes transferring the food product on a flume using a venturi effect.

17. The method of claim 10, further comprising controlling the temperature of a water bath disposed beneath the tempering belt.

18. A food product cooker, comprising:
means for cooking the food product to a desired moisture level;
means for tempering the food product after it has been cooked to the desired moisture level; and
means for transferring the food product from the means for cooking to the means for tempering, wherein the means for transferring is operatively connected to an output of the means for cooking and further operatively connected to the means for tempering.

19. The food product cooker of claim 18, wherein the means for cooking is a continuous means for cooking.

20. The food product cooker of claim 19, wherein the means for tempering belt is a continuous means for tempering.

21. The food product cooker of claim 19, wherein the means for transferring includes a bucket lift.

22. The food product cooker of claim 19, wherein the means for transferring the food product is a continuous means for transferring.

23. The food product cooker of claim 22, wherein the means for transferring includes a venturi flume.

24. The method of claim 18, wherein the means for tempering includes a tempering belt, a water bath disposed near the tempering belt, and a means for controlling the temperature of a water bath disposed beneath the tempering belt.

25. A food product cooker comprising:
a blancher, having a blancher inlet and a blancher outlet; and
a temperer, having a tempering belt, a tempering belt inlet and a tempering belt outlet, and a source of pulsed electric field energy, wherein the tempering belt inlet and blancher outlet are disposed to provide for the transfer of food product from the blancher outlet to the tempering belt inlet, and further wherein the source of energy is disposed to direct the pulsed electric field energy towards the belt.
